(19) United States
(12) Patent Application Publication
(10) Pub. No.: US 2004/0231147 A1
(43) Pub. Date: Nov. 25, 2004

(54) Fiber puller

(76) Inventor: Joseph D. La Scola, Ocean County, NJ (US)

Correspondence Address: Henry T. Brendzel, P.O. Box 574, Springfield, NJ, 07081, US

(21) Appl. No.: 10/840,156

(22) Filed: May 6, 2004

Related U.S. Application Data
(60) Provisional application No. 60/469,468, filed on May 9, 2003.

(51) Int. Cl. H01R 13/00

(52) U.S. Cl. 29/748; 29/750

(57) ABSTRACT

A pliers-like puller for inserting, or extracting, a plug from a corresponding socket, where the plug carries a conductor that is attached to the plug, where one of the puller's jaws includes a tooth followed by an accommodation space for wings of the plug. A section of the puller's handles is bent to form a pistol handle-like gripping section.

### RELATED APPLICATIONS

This non-provisional patent application is related to, and claims the benefit of, U.S. Provisional Application No. 60/469,468 filed on May 9, 2003.

### BACKGROUND

This invention relates generally to pliers-like pullers and, more particularly to pullers for extracting plug-terminated cables from their associated receptacles.

Similar to electrical connections, optical connections can be realized with couplers: a male coupler element, sometimes referred to as a plug, that is adapted to be inserted to and engaged by a female coupler element, sometimes referred to as a socket. FIG. 1 illustrates one prior art fiber coupler that comprises socket 10 and plug 20. Plug 20 includes a preselected length section of optical fiber 21 that extends from a head end of the plug, followed by a plug portion 22 having a generally rectangular cross section that is adapted to be inserted into the generally rectangular opening 11 of socket 10. Plug portion 22, which is generally rigid, surrounds or encases the cable. Following plug portion 22 there is a generally cylindrical rigid plug portion 23, which in turn is followed by a relatively flexible sleeve 24. The optical fiber passes through portion 23 and sleeve 24, and continues on to some remote destination (not shown).

In order to enable plug 20 to sit securely in socket 10, plug portion 22 includes a flexible wing 25 that is attached toward the front end of plug portion 22, and in a cantilevered manner extends backward, away from the head end of plug portion 22 and away from the center axis of the optical cable that passes through plug 20. The wing has a shape that is adapted to mate with an opening in socket 10 so that once inserted, plug 20 cannot be extracted from socket 10 unless wing 25 is bent toward the center axis. Of course, wing 25 is constructed to be “springy” in that it can be bent by application of a relatively small force, essentially innumerable number of times without breaking, and retuned to its original position by removal of the force.

To assist in bending wing 25 toward the center axis, plug portion 23 also has a wing. This wing, marked 26 in FIG. 1, is attached toward the back end of plug portion 23 and extends in a cantilevered manner toward to front end of socket 10, and also outward away from the center axis. The length and arrangement of wing 26 are such that a small hook that is located at its end and points toward the center axis slightly overlaps and is above the end of wing 25. Wing 26 is also “springy,” and the consequent arrangement of wings 25 and 26 is such that application of force by pinching wing 26 toward the center axis of the optical cable (for example with a thumb and the forefinger) pinches wing 25, and that allows plug 20 to be extracted from socket 10

The dimensions of elements 10 and 20 are fairly small. Specifically, dimension A is on the order of 0.25 inches, and dimension B is on the order of 0.35 inches. Dimension C, by comparison, is significantly larger, on the order of 3 inches. Typically, a significant number of sockets 10 are placed together on a panel, in an array of rows and columns, with the spacing between the sockets (both intra-row and intra-column) being on the order of 0.1 inches. When a large number of optical cables are plugged in, given the narrow spacing between plugs and the relatively long extension of sleeve 24, it is extremely difficult to access wings 25 and 26 for the purpose of pulling plug 20 out of socket 10.

It is desirable, therefore, to have a specialized tool that could effectively and safely remove plug 20 from socket 10 even in circumstance where a number of sockets 10 are arranged in close proximity to each other.

### SUMMARY

An advance in the art is realized with a pliers-like puller for inserting, or extracting, a plug from a corresponding socket, where the plug carries, for example, an optical fiber that is attached to the plug with an extended sleeve. The puller has handles at a grabbing end of the puller, a pair of jaws at a working end of the puller, and a pivot axis therebetween. The jaws extend farther from the pivot axis than the length of the plug and the sleeve and are arranged so that at their most proximate position to each other, an accommodation space is maintained between the jaws that is sufficient to avoid pinching the optical cable. One of the jaws has a tooth-like extension at its tip to facilitate pinching a wing of a plug (i.e., pressing the wing to ward the center axis of the plug) so as to enable the plug to be released and removed from a socket. Advantageously the handles of the puller are bent to allow a more natural and, therefore, ergonomically better positioning of a person's hand when attempting to insert, or remove, plugs.

### BRIEF DESCRIPTION OF THE DRAWING

FIG. 1 depicts a plug and socket coupler adapted for optical fibers;

FIG. 2 illustrates a pliers-like puller in accord with the principles of this invention;

FIG. 3 shows the tip portion of the jaws in FIG. 2 puller, in greater detail;

FIG. 4 shows the puller positioned to extract a plug, with the jaws extended;

FIG. 5 shows the puller with the jaws closed, in the process of pulling out a plug;

FIG. 6 depicts the tip portion of a different embodiment; and

FIG. 8 shows a puller with a replaceable tip.

### DETAILED DESCRIPTION

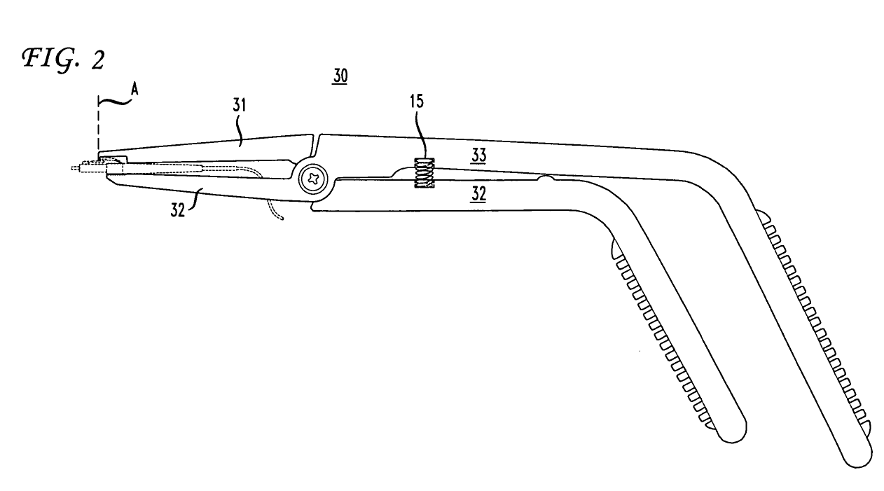

FIG. 2 shows the side view of an illustrative embodiment of a puller 30 in accord with the principles disclosed herein. It is a pliers-like device that is made up of, basically, two pieces. A first piece has a jaw portion 31, a handle portion 32, and a pivot region in between. The jaw portion and the handle portion in the neighborhood of the pivot region are generally parallel to each other but not co-aligned. The center of the pivot region includes a cylindrical pin to serve as a pivot axis. The pin's axis is perpendicular to the side view. Essentially all of the characterizing features of the puller are depicted by the side view and, therefore, that is the only view shown.

The second piece of the puller is complementarily similar. It has a jaw portion 33, a handle portion 34, and a pivot region therebetween that includes a hole adapted to allow the pin of the first piece to pass through. When the pin of the first piece is passed through the hole of the second piece a pliers-like device results. Advantageously, the pivot regions of the two pieces are constructed so that when the pliers-like device is assembled, the jaws are aligned with each other; i.e., over each other. Thus, when the handles are separated, the jaws separate as well, and when the handles are squeezed together, the jaws squeeze together as well. This arrangement, of two pieces that are joined to form a pliers-like device, is quite conventional and there are many variations that can be employed in connection with the construction of a pliers-like puller without departing from the spirit and scope of this invention.

Optionally, a spring element 15 holds the jaws apart when no pressure is applied to the handles.

The amount of force that is necessary to apply to wing 26 in order to enable plug 20 to be pulled out of socket 10 is quite low and, therefore, there is no need to be concerned with for the mechanical advantage that the puller should provide through the pliers action. Accordingly, the length of the jaws can be commensurate with the length of the handles. This is fortuitous because, as indicated above, the length of sleeve 24 is on the order of 3 inches, which requires jaws 31 and 33 to be longer, and should a large mechanical advantage be necessary, the length of the handles might have had to be excessive. In the FIG. 2 embodiment, the length of the jaws might be on the order of 3.5 inches, and the length of the handles might be only slightly longer (for example. 6 inches).

For convenient handling of the puller during an insertion, or extraction process, it was found advantageous to have the handles extended by a length that is convenient for holding the puller, for example 3 to 4 inches, and angling this extension (in the plane of the side view) at an angle of approximately 60 degrees relative to the axis of proximate symmetry. This gives the puller a pistol grip-like handle. When holding the puller at the bend handles, a specific one of the jaws naturally becomes the top jaw.

The jaws of the FIG. 2 puller are at least long enough to accommodate sleeve 24, wing 26, and a short distance thereafter that is sufficient to engage wing 25. A preferred length is slightly longer, by approximately the recommended minimum radius of curvature of an optical fiber that is attached to the plug that is extracted.

The construction of the jaws is such that when the jaws are moved to their most closed position (i.e., closest to each other), an accommodation space remains between the jaws, to accommodate plug portions 22 and 23, as well as sleeve 24, without significantly pinching them. In this most closed position, the jaws do pinch wing 25 sufficiently to enable extraction of plug 20 from socket 10. The pinching of wing 25 may be effected by application of force to wing 25, by application of force to wing 26, or by application of force to both wings 25 and 26.

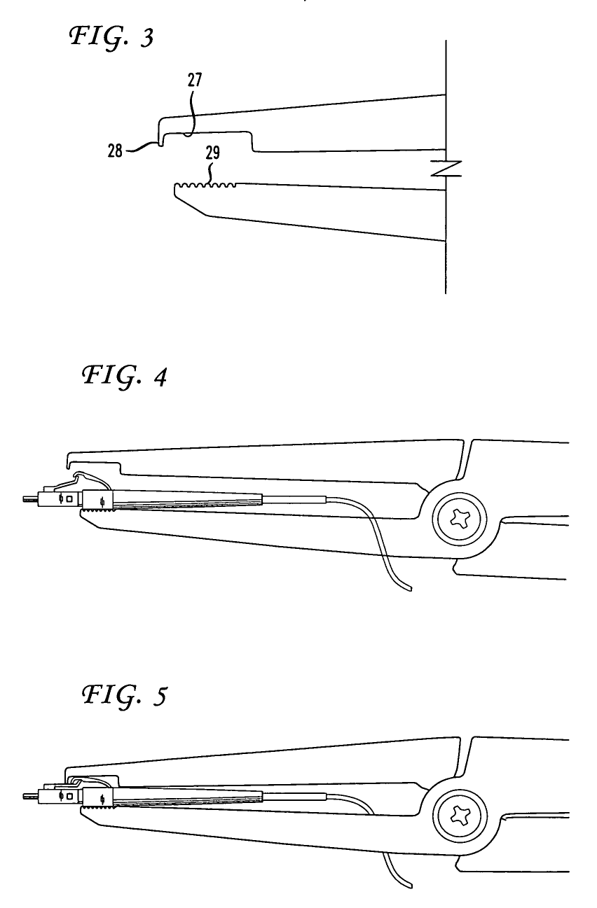

FIG. 3 depicts an enlarged view of the puller's tip. As can be seen, the top jaw includes a U-shaped channel 27 that creates a tooth 28 at the end of the jaw, and also increases the accommodation space for the width of the channel. The primary purpose for the U-shaped channel is the creation of the tooth and the creation of some accommodation space for wings 25 and 26. The primary purpose of the tooth is to provide a means to be inserted in front of the wing 26 hook, and thereby to allow the application of an extraction force on plug 10 by the puller—via the tooth applying a force on wing 26, which translates the force to plug portion 23.

A secondary purpose of the tooth is to pinch down on wing 25 in order to release the plug from the socket—if the depth of the U-shaped channel is too deep to pinch wing 25 by action of wing 26. Stated differently, the height of the tooth need not be greater than the size of the bend in wing 26, although it can be somewhat greater. The tooth should not be so long that the edge of tooth 28 could hit wing 25, depress wing 25 as far as it can go, and still not have the top jaw engage any other portion of plug 10 (that is, wing 26, or plug portion 22). Thus, the depth of the U-shaped channel may be shallow enough to merely accommodate the thickness of wing 26 when it is depressed on top of wing 25. The width of the U-shaped channel should be sufficient to accommodate wing 26 in its pinched state (i.e., pressed toward the center axis of plug 20); for example, on the order of 0.04 inches. The tooth, which can be formed by simply creating a channel just a short distance away from the jaw's tip, is advantageously made thinner than it is deep; i.e., less that 0.04 inches thick.

To facilitate insertion of the puller between adjacent sockets, the width of the jaws is advantageously less the width of the socket to be extracted plus the space between sockets, and the thickness of the jaws is less than the separation between rows of sockets; for example, less than 0.1 inches. Also to facilitate insertion of the jaws toward a socket that has an inserted plug, and the engagement of tooth 28 in front of the bend in wing 26 of the inserted plug, the lower jaw is slightly shorted than the top jaw, giving the tooth in the top jaw a bucktooth effect. Lastly, the lowerjaw 's surface that is used to grab an object such as plug 20 is roughened to insure sufficient friction to avoid slipping.

FIGS. 4 and 5 show the FIG. 2 puller with the jaws open, and with the jaws closed, respectively.

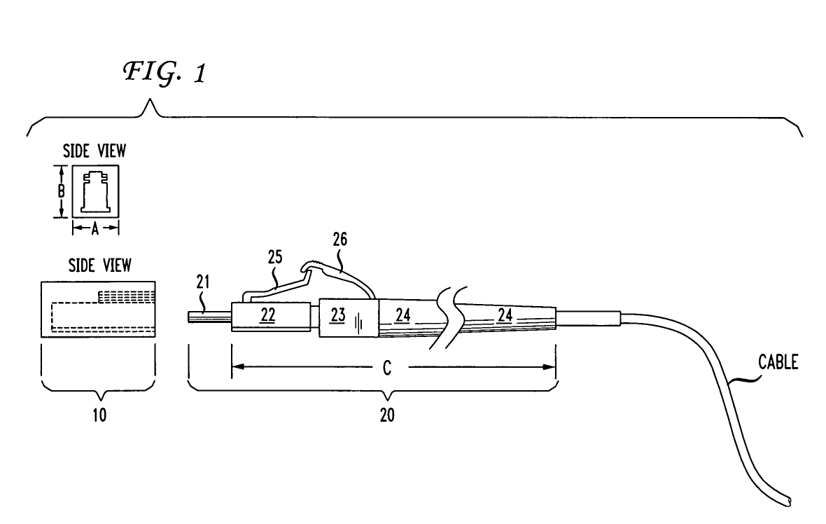

While the puller disclosed herein is described in connection with the coupler shown in FIG. 1, it should be realized that a puller that comports with the principles disclosed herein can be employed with other couplers as well. It may be noted in passing, for example, that a commercial coupler like shown in FIG. 1 is available in one-piece pairs, to allow handling of a pair of optical cables as a unit.

Also, illustratively, the FIG. 2 puller, or a modified puller that is still in conformance with the principles disclosed herein, can be used for the conventional telephone couplers of the RJ family of couplers (e.g., RJ-45).

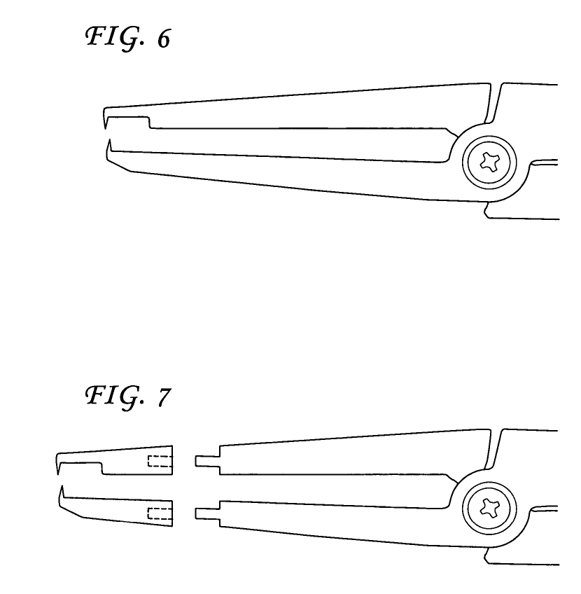

FIG. 6 shows a puller that has a different jaw-tips arrangement. It includes a tooth in the lower jaw, as well as in the upper jaw, and the two teeth are substantially aligned with each other. Also, the two teeth are relatively sharp so that they can bite into the plug that is being extracted, thereby providing the necessary friction.

FIG. 7 presents a puller that has replaceable jaws—so that, for example, the same puller can be sold with a variety of jaws that can be attached at will by the user.

Thus, it should be understood that the above-described embodiment is merely illustrative of this invention, and that other embodiments can be created that, nevertheless, comport with the principles disclosed herein, which are defined in the following claims.

1. A puller comprising elements A and B that are joined about a pivot axis to form a pliers-type puller tool with a pair of jaws to one side of the pivot axis and a pair of handles to an opposite side of said pivot axis, each of said jaws having a tip at a distal end, away from said pivot axis, and the pliers-type puller is adapted to open and close said jaws by moving said handles toward, or away from, a pull-push axis extending perpendicularly to said pivot axis, respectively, the improvement comprising:
a tooth at the tip of the distal end of the jaws of element A; and
a first accommodation space in jaw A, following said tip, toward said pivot axis.

2. The puller of claim 1 where said tooth and said first accommodation space are created by including a channel in jaw A, perpendicularly to said pull-push axis, said channel being positioned a selected distance C away from said distal end of said one of the jaws.

3. The puller of claim 2 where said channel has a generally even depth of approximately 0.04 inches, and said distance C is less than said depth.

4. The puller of claim 8 where said channel is U-shaped.

5. The puller of claim 1 where said first accommodation space is adapted to accommodate wings of a coupler element.

6. The puller of claim 1 where said jaws of elements A and B are constructed to form a second accommodation space between said jaws, which second accommodation space extends along said push-pull axis toward said pivot axis for a preselected distance, where said second accommodation space is of sufficient girth—even when said jaws are at the most closed position—to accommodate at least a selected length of a plug, and a length D of a signal-carrying conductor extending from said plug, where said length D corresponds to a radius of convenient curvature of said signal-carrying conductor.

7. The puller of claim 8 where said conductor is optical or electrical.

8. The puller of claim 6 where said conductor is optical, and said plug includes a sleeve surrounding said conductor of a given length, and said selected length of said plug includes said given length of said sleeve.

9. The puller of claim 1 where
the handle of element A comprises a first segment that is substantially parallel to said push-pull axis and extends from said pivot axis for a selected distance X, followed by a first grip segment that is angled away from said push-pull axis and extends for a distance sufficient to accommodate at least the forefinger of a hand that has a v-shaped space between the forefinger and the thumb of the hand; and
the handle of element B comprises first segment that is substantially parallel to said push-pull axis and extends from said pivot axis for a selected distance of more than X, followed by a grip segment that is angled toward said first grip segment and extends for a distance sufficient to engage said v-shaped space of a hand having its forefinger engaged with said first grip segment.

10. The puller of claim 1 where the tip of the jaw of element B extends from said pivot axis a distance that is shorter than distance fo said tooth from said pivot axis.

11. The puller of claim 1 where said tip of the jaw of element B includes a portion that is un-smooth, which portion engages a plug that is being removed by said puller.

12. The puller of claim 1 where said tip of the jaw of element B includes a tooth.

13. The puller of claim 1 where said tooth and said accommodation space are realized in said jaw of element A by means of an extension that is attached to said element A.
